(19) United States
(12) Patent Application Publication
(10) Pub. No.: US 2025/0367077 A1
(43) Pub. Date: Dec. 4, 2025

(54) DEVICE AND METHOD FOR TRANSFERRING LIQUID MEDICINE FROM LOW-PRESSURE SEALED CONTAINER TO HIGH-PRESSURE SEALED CONTAINER

(71) Applicant: HANGZHOU QIANTANG LONGYUE BIOTECHNOLOGY CO., LTD., Hangzhou City (CN)

(72) Inventors: Liqun WU, Hangzhou (CN); Xuecai Yang, Hangzhou (CN)

(73) Assignee: HANGZHOU QIANTANG LONGYUE BIOTECHNOLOGY CO., LTD., Hangzhou City (CN)

(21) Appl. No.: 18/884,404

(22) Filed: Sep. 13, 2024

(30) Foreign Application Priority Data
May 29, 2024 (CN) 202410681799.9

(51) Int. Cl. A61J 1/20

(52) U.S. Cl. CPC A61J 1/20

(57) ABSTRACT

A device for transferring liquid medicine from a low-pressure sealed container to a high-pressure sealed container, including: a first channel configured to be able to communicate the low-pressure sealed container with the high-pressure sealed container in gas; a second channel configured to be able to communicate the low-pressure sealed container with the high-pressure sealed container in liquid; a first puncture end configured to pierce the low-pressure sealed container; a second puncture end configured to pierce the high-pressure sealed container, wherein first ends of the first channel and the second channel are located at the first puncture end, second ends of the first channel and the second channel are located at the second puncture end; an on-off valve arranged on the first channel and the second channel, wherein the first channel is opened before the second channel.

### TECHNICAL FIELD

The present disclosure is related to the field of medical equipment, and more particularly to a device and method for transferring liquid medicine from low-pressure sealed container to high-pressure sealed container.

### STATE OF THE ART

In the process of dispensing medicine, it is often necessary to transfer the liquid medicine from a low-pressure container to a high-pressure container. The conventional practice and the problems are as follows:
1. Opening the low-pressure container and the high-pressure container separately, releasing the pressure and then transferring. In this way, the liquid medicine will be exposed to the air during the operation, and the liquid medicine may be contaminated by bacteria. In addition, the liquid medicine may splash or volatilize to produce harmful gases during the opening process, thereby injuring medical staff.
2. The liquid medicine in the low-pressure container is extracted by a syringe with a needle or other device, and then injected into the high-pressure container. This method can effectively avoid the risk of the sterile system being destroyed due to the large-area exposure of the liquid medicine in the first method. However, due to the large amount of medicine, medical staff need to transfer the medicine many times, and the liquid medicine may leak during the transfer process. In particular, some anticancer drugs are highly corrosive and may cause irreversible damage to medical staff. At the same time, the sharp steel needle may cause accidental puncture, which results in unnecessary medical accidents.
3. Use existing single-channel pipette to pierce low-pressure container and high-pressure container respectively to transfer liquid. Liquid overflow may be caused during transfer due to the imbalance of air pressure in two containers.
4. For example, CN202236337U discloses a dual-channel pipette. Although it can realize the transfer and mixing of medicine, the dual channels are all through. In order to improve the efficiency of medicine mixing, the liquid channel is usually as large as possible, which will cause the bottle needle to be too large in size, so that resistance is too much when puncturing a small-dose medicine bottle or container, which is inconvenient to use. Furthermore, since the dual channels are not provided with a switch, when piercing the low-pressure container, the low-pressure container will be communicated to the outside air, which causes the liquid medicine to be contaminated. In addition, in order to ensure that the gas in the high-pressure sealed container enters the low-pressure container first, the gas channel is usually designed to be longer than the liquid channel, so that the gas channel is ensured to enter the high-pressure container first, but at this time the liquid channel has not entered the high-pressure container, and the liquid channel hole is not sealed by the sealing rubber. Under the action of air pressure and water pressure, the liquid medicine in the low-pressure container will flow out from the liquid channel and thus the container leaks. In severe cases, some corrosive liquid medicine may even cause harm to the human body.

Therefore, the existing operation methods cannot meet the actual use requirements of transferring liquid in a closed state from a low-pressure container to a high-pressure container without exposure.

### SUMMARY

In view of the problem that the existing transfer method may cause exposure and leakage, the disclosure provides a device and method for transferring liquid medicine from a low-pressure sealed container to a high-pressure sealed container. The technical problems existing in the existing technology will be solved by opening the gas path and the liquid path in sequence through the on-off valve.

The device for transferring liquid medicine from a low-pressure sealed container to a high-pressure sealed container according to the disclosure includes:
a first channel configured to be able to communicate the low-pressure sealed container with the high-pressure sealed container in gas,
a second channel configured to be able to communicate the low-pressure sealed container with the high-pressure sealed container in liquid,
a first puncture end configured to pierce the low-pressure sealed container, wherein first ends of the first channel and the second channel are located at the first puncture end;
a second puncture end configured to pierce the high-pressure sealed container, wherein second ends of the first channel and the second channel are located at the second puncture end;
an on-off valve arranged on the first channel and the second channel and configured to control the opening and closing of the first channel and the second channel, wherein the first channel is opened before the second channel.

The first puncture end and the second puncture end pierce the low-pressure sealed container and the high-pressure sealed container respectively. At this time, the on-off valve remains closed. The first channel is opened first, and the gas circulates first, so that the liquid does not enter the gas channel, which affects the accuracy of dispensing, and does not block the gas channel. The air pressure in the low-pressure sealed container and the air pressure in the high-pressure sealed container can quickly remain consistent or have a small difference, so that the liquid will not overflow under the action of the air pressure. At this time, the recirculation of the liquid can solve the problem of liquid leakage in the existing technology.

In addition, the on-off valve includes a valve core configured with a first through hole and a second through hole, the first through hole and the second through hole are respectively located in a middle position of the first channel and the second channel, and the first channel is opened before the second channel by driving the valve core. The first through hole and the second through hole control the on-off of the first channel and the second channel respectively, so that the on-off of gas and liquid can be achieved by only controlling the action of the valve core. The grad of integration is high, and the operation is convenient. Through this solution, the shapes of the first through hole and the second through hole are not limited. They can be circular holes, square holes, etc. with constant aperture, or conical holes, etc. with smoothly changing aperture, or stepped holes, etc. with discontinuously changing aperture.

As a variant, the valve core is a rotary shaft, the first through hole and the second through hole are arranged side by side on the rotary shaft, the rotary shaft is configured with an extension groove along a rotation direction at the first through hole, the extension groove is communicated to the first through hole, so that the first channel is opened before the second channel.

As a second variant, the valve core is a rotary shaft, the first through hole and the second through hole are arranged side by side on the rotary shaft, and an aperture of the first through hole is larger than an aperture of the second through hole, so that the first channel is opened before the second channel.

As a third variant, the valve core is a pull-out rod, the pull-out rod is configured with an extension groove along a pull-out direction at the first through hole, the extension groove is communicated to the first through hole, and the distance between the extension groove and the first channel in the pull-out direction is smaller than the distance between the second through hole and the second channel, so that the first channel is opened before the second channel.

As a fourth variant, the valve core is two pull-out rods, the first through hole and the second through hole are respectively arranged on the two pull-out rods, the first channel is opened before the second channel by pulling the two pull-out rods in sequence. Through this solution, the first through hole and the second through hole can be two through holes with equal or unequal apertures. By pulling the two communication rods in sequence, the first channel and the second channel can be opened in sequence. The first communication rod and the second communication rod can also be distinguished by configuring different lengths to prevent errors.

In addition, the device for transferring liquid medicine from a low-pressure sealed container to a high-pressure sealed container further includes a housing connecting the first puncture end and the second puncture end, the valve core is arranged in the housing, the housing and the valve core are matched through a groove and a buckle, so as to determine the driving position of the valve core. It is feasible to provide a groove on the housing and a buckle on the valve core, or to provide a buckle on the housing and a groove on the valve core, and the purpose is to determine the position of the valve core by limiting the groove and the buckle.

In addition, the housing is configured with a holder extending toward the first puncture end, the holder is configured to fix or clamp the low-pressure sealed container. Generally, the low-pressure sealed container has a small caliber. It is not easy to position during puncture, and it is easy to deviate from the ideal position when force is applied. Therefore, a holder is provided to facilitate smoother insertion of the first puncture end into the low-pressure sealed container.

In addition, the first end of the first channel is higher than the first end of the second channel, wherein the end of the first channel is located above liquid in the low-pressure sealed container, so that an end of a first communication tube is able to contact the gas in the low-pressure sealed container and the end of the second channel is submerged in the liquid in the low-pressure sealed container.

In addition, the second end of the first channel is higher than the second end of the second channel, and the height difference between them is greater than a height of a rubber stopper of the high-pressure sealed container.

A method for transferring liquid medicine from a low-pressure sealed container to a high-pressure sealed container including:
Step 1, ensuring that the on-off valve is closed, the first channel and the second channel are blocked;
Step 2, piercing the first puncture end and the second puncture end into the low-pressure sealed container and the high-pressure sealed container respectively, wherein the low-pressure sealed container is located above the high-pressure sealed container;
Step 3, driving the on-off valve, so that the first channel is first in an open state, so that the gas in the high-pressure sealed container flows to the low-pressure sealed container, the second channel is in a closed state at this time;
Step 4, continuing to drive the on-off valve, so that the first channel and the second channel are simultaneously in an open state, so that the liquid in the low-pressure sealed container flows into the high-pressure sealed container.

The beneficial effects of the disclosure are in that:
1) The disclosure is provided with an on-off valve. When piercing into a low-pressure or high-pressure container, the on-off valve is kept closed, so as to ensure that the liquid medicine is not exposed and contaminated;
2) The first channel is opened before the second channel by the on-off valve, so that the gas flows first and the liquid does not flow into the gas channel, so as to ensure the accuracy of the dispensing ratio; at the same time, it can ensure that the low-pressure container and the high-pressure container achieve pressure balance first, and then, under the action of the gravity of the liquid medicine, ensure that the liquid medicine can be successfully transferred from the low-pressure sealed container to the high-pressure sealed container;
3) It is not necessary to enlarge the liquid channel to achieve liquid medicine transfer, which reduces the overall diameter of the puncture needle and reduces the puncture resistance.

### DESCRIPTION OF THE DRAWINGS

FIG. 1 is a schematic diagram of an overall structure of Embodiment 1;

FIG. 2 is a use state diagram of Embodiment 1;

FIG. 3 is a schematic diagram of an internal structure of Embodiment 1;

FIG. 4 is a schematic diagram of a rotary shaft of Embodiment 1;

FIG. 5 is a schematic diagram of a housing of Embodiment 1;

FIG. 6 is a schematic diagram of a rotary shaft of Embodiment 2;

FIG. 7 is a schematic diagram of one pull-out rod of Embodiment 3;

FIG. 8 is a schematic diagram of two pull-out rods of Embodiment 4;

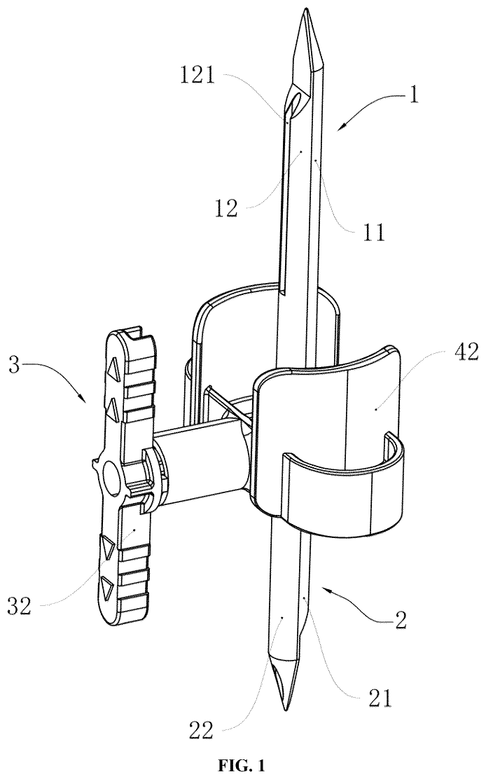

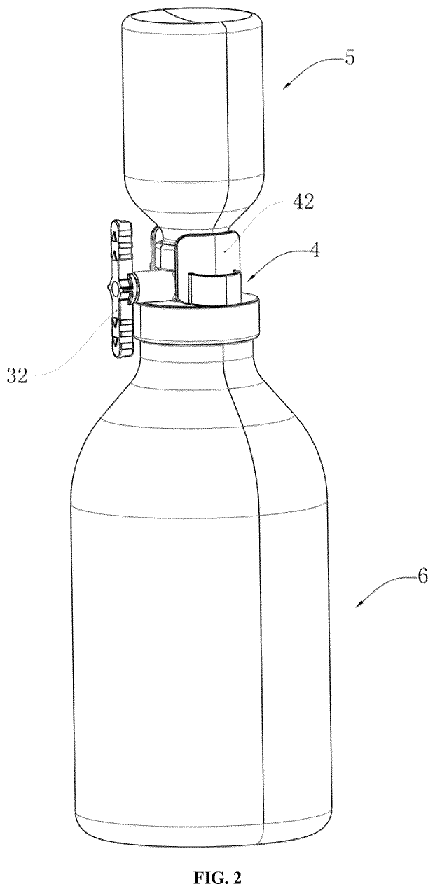

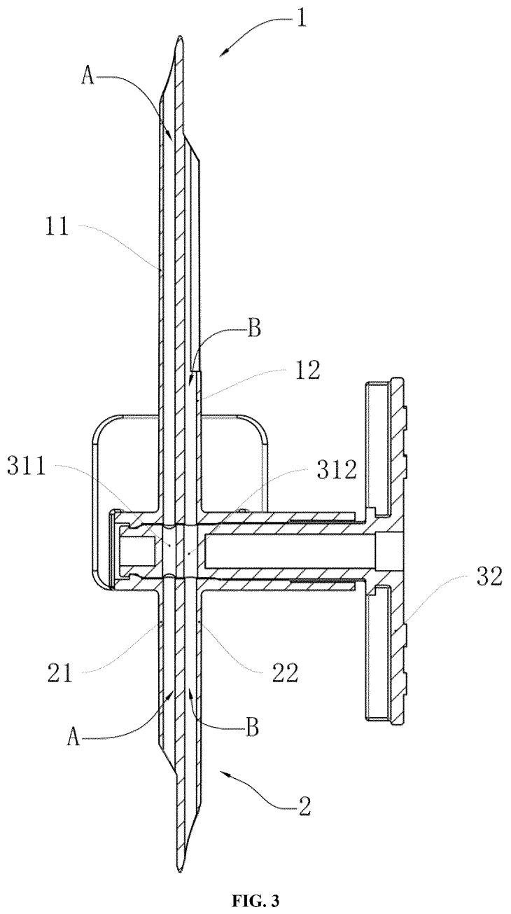

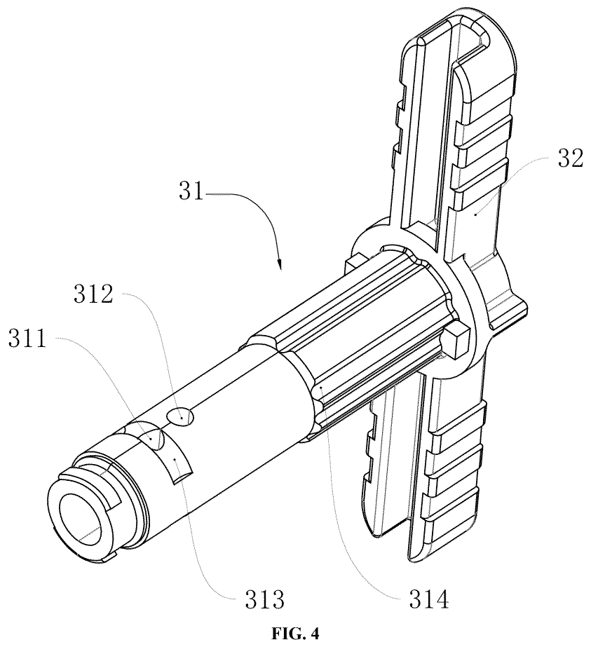

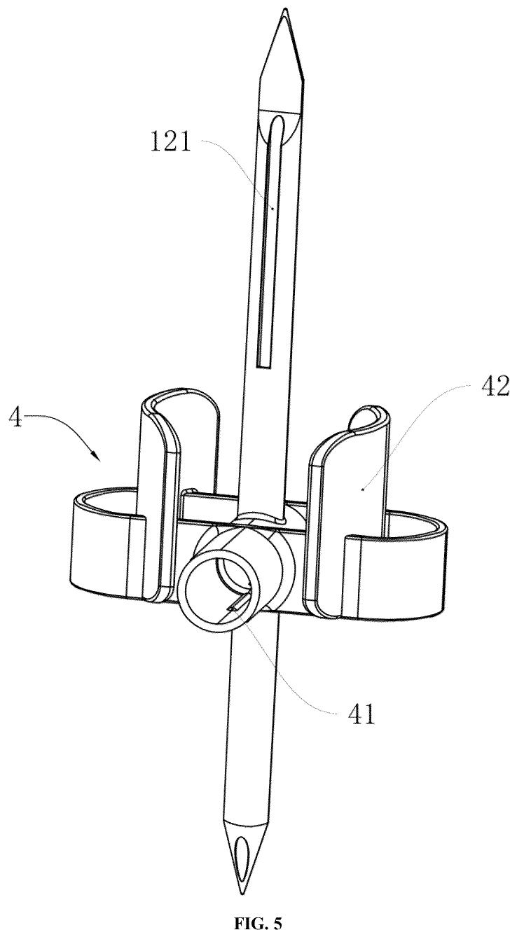

Among them, 1—first puncture end; 11—first end of the first channel; 12—first end of the second channel; 121—notch; 2—second puncture end; 21—second end of the first channel; 22—second end of the second channel; 3—on-off valve; 31—rotary shaft; 311—first through hole; 312—second through hole; 313—extension groove; 314—groove; 32—handle; 4—housing; 41—buckle; 42—holder; 5—low-pressure sealed container; 6—high-pressure sealed container; A—first channel; B—second channel.

### EMBODIMENTS

The technical solutions of the embodiments of the disclosure are explained and illustrated below in conjunction with the accompanying drawings of the disclosure. However, the following embodiments are only preferred embodiments of the disclosure and are not exhaustive. Based on the embodiments in the implementation, other embodiments obtained by those of skill in the art without making any creative work shall fall within the scope of protection of the disclosure.

### Embodiment 1

The embodiment is a device for transferring liquid medicine from a low-pressure sealed container to a high-pressure sealed container including:
a first channel A configured as a gas path channel, and configured to be able to communicate the low-pressure sealed container 5 with the high-pressure sealed container 6 in gas,
a second channel B configured as a liquid path channel, and configured to be able to communicate the low-pressure sealed container 5 with the high-pressure sealed container 6 in liquid,
a first puncture end 1 configured to pierce the low-pressure sealed container 5, wherein first ends of the first channel A and the second channel B are located at the first puncture end 1. As shown in this embodiment, the first ends of the first channel A and the second channel B share a first puncture end 1. Of course, the first ends of the first channel A and the second channel B may also be located on different first puncture ends 1, respectively.

a second puncture end 2 configured to pierce the high-pressure sealed container 6, wherein second ends of the first channel A and the second channel B are located at the second puncture end 2. As shown in this embodiment, the second ends of the first channel A and the second channel B share a second puncture end 2. Of course, the second ends of the first channel A and the second channel B may also be located on different second puncture ends 2, respectively.

an on-off valve 3, the on-off valve 3 arranged on the first channel A and the second channel B and configured to control the opening and closing of the first channel and the second channel.

The on-off valve 3 includes a valve core with a first through hole 311 and a second through hole 312. The valve core is a rotary shaft 31. The first through hole 311 and the second through hole 312 are arranged side by side on the rotary shaft 31. The rotary shaft 31 is configured with an extension groove 313 along a rotation direction at the first through hole 311. The extension groove 313 is communicated to the first through hole 311, so that the first channel A is opened before the second channel B. In this embodiment, “open” means that the through hole communicates the entire channel.

The first puncture end 1 and the second puncture end 2 pierce the low-pressure sealed container 5 and the high-pressure sealed container 6 respectively. At this time, the on-off valve 3 remains closed. The first channel A is opened first, and the gas circulates first, so that the liquid does not enter the gas channel, which affects the accuracy of dispensing, and does not block the gas channel. The air pressure in the low-pressure sealed container 5 and the air pressure in the high-pressure sealed container 6 can quickly remain consistent or have a small difference, so that the liquid will not overflow under the action of the air pressure. At this time, the recirculation of the liquid can solve the problem of liquid leakage in the existing technology.

In this embodiment, the extension groove 313 expands the communication area of the first through hole 311 in the rotation direction of the rotary shaft 31, so that the first channel A can be communicated first and then the second channel B can be communicated. In addition, the first through hole 311 and the second through hole 312 are both arranged on the rotary shaft 31, so that the on-off of gas and liquid can be achieved by only controlling the action of the rotary shaft 31. The grad of integration is high, and the operation is convenient. When the portion on the rotary shaft 31 outside the first through hole 311 and the second through hole 312 are located corresponding to the first channel A and the second channel B, the first channel A and the second channel B can be blocked, so as to effectively prevent air leakage and liquid leakage.

The housing 4 connects the first puncture end 1 and the second puncture end 2. The rotary shaft 31 is arranged in the housing 4. The housing 4 and the rotary shaft 31 are matched through a groove 314 and a buckle 41, so as to determine the driving position of the valve core. In this embodiment, the housing 4 is provided with a buckle 41, the rotary shaft 31 is provided with a groove 314, so as to determine the position of the valve core by limiting the buckle 41 and the groove 314.

The housing 4 is configured with a holder 42 extending toward the first puncture end 1, the holder 42 is configured to fix or clamp the low-pressure sealed container 5. Generally, the low-pressure sealed container 5 has a small caliber. It is not easy to position during puncture, and it is easy to deviate from the ideal position when force is applied. Therefore, a holder is provided to facilitate smoother insertion of the first puncture end 1 into the low-pressure sealed container 5.

A handle 32 is configured on the rotary shaft 31, and the handle 32 is located outside the housing 4. The rotation of the rotary shaft 31 can be controlled by rotating the handle 32.

The first end 11 of the first channel is higher than the first end 12 of the second channel, wherein the end of the first channel is located above liquid in the low-pressure sealed container 5, so that an end of a first communication tube is able to contact the gas in the low-pressure sealed container 5 and the end of the second channel is submerged in the liquid in the low-pressure sealed container 5.

The second end 21 of the first channel is higher than the second end 22 of the second channel, and the height difference between them is greater than a height of a rubber stopper of the high-pressure sealed container 6. This arrangement ensures that the gas path is pulled out of the bottle stopper first, and the liquid path remains in the container. Even if liquid splashes, it is still in the container, which avoids the possibility of medical staff being injured.

The gas flows under the impetus of air pressure, that is, flows from the high-pressure closed container 6 to the low-pressure closed container 5. In this embodiment, a notch 121 is configured at the first end 12 of the second channel, so as to reduce the amount of residual liquid in the low-pressure sealed container 5.

The cross section of the second channel B is arc-shaped or crescent-shaped. The second channel B with this cross-sectional shape can facilitate the flow of liquid and effectively reduce the impact on the inner walls of the first puncture end 1 and the second puncture end 2.

The bottom end of the lower gas channel is kept above the liquid surface. The lower bottle body is generally a saline bottle for infusion. A part of the space is generally reserved at the bottle mouth, and the needle is generally located in this space when puncturing and does not contact with the liquid surface.

### Embodiment 2

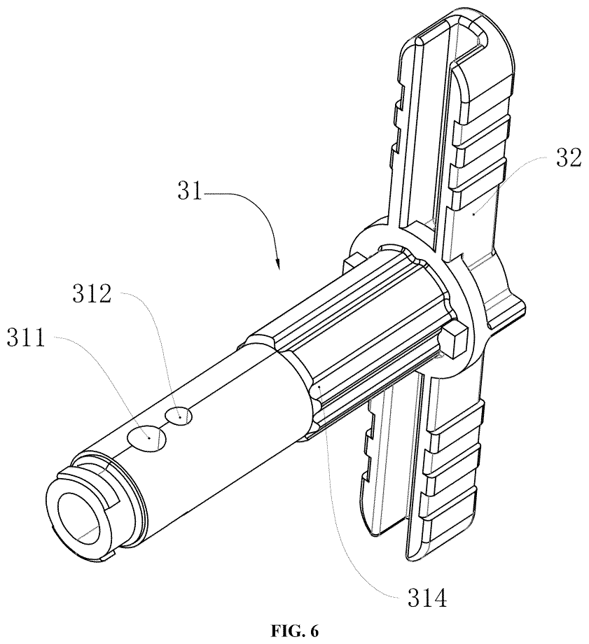

As shown in FIG. 6, this embodiment is different from embodiment 1 in that: the valve core is a rotary shaft, the first through hole 311 and the second through hole are arranged side by side on the rotary shaft, and an aperture of the first through hole 311 is larger than an aperture of the second through hole, so that the first channel is opened before the second channel. The aperture of the first through hole 311 is larger than that of the second through hole 312. When the rotary shaft 31 rotates, the first through hole 311 with a larger aperture is first communicated to the first channel A, and the second through hole 312 with a smaller aperture is then communicated to the second channel B. The two through holes are arranged in parallel to ensure that the first channel A and the second channel B are opened at the same time when the rotary shaft is rotated.

### Embodiment 3

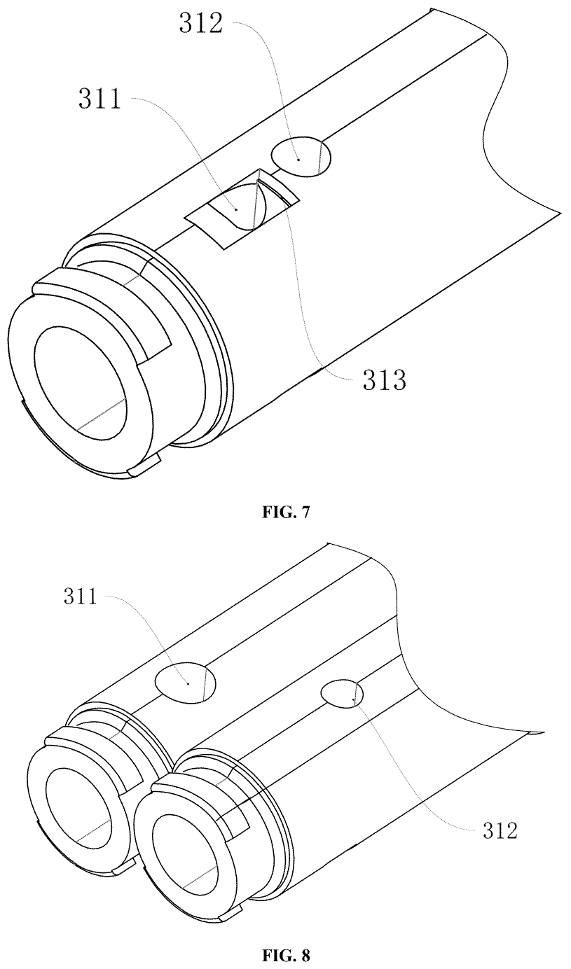

As shown in FIG. 7, this embodiment is different from embodiment 1 in that: the valve core is a pull-out rod, the pull-out rod is configured with an extension groove 313 along a pull-out direction at the first through hole 311, the extension groove 313 is communicated to the first through hole 311, and the distance between the extension groove and the first channel A in the pull-out direction is smaller than the distance between the second through hole 312 and the second channel B, so that the first channel A is opened before the second channel B. In this embodiment, the first through hole 311 and the second connecting hole 312 are integrated on the pull-out rod. It is only necessary to control the pulling position of the pull-out rod to achieve that the first through hole 311 is communicated to the first channel A first and the second through hole is communicated to the second channel B later. The configuring of the extension groove 313 enable communicating the first channel by moving the pull-out rod a shorter distance. Two channels can in a communicated state at the same time by continuous pulling. It can also be: the first through hole and the second through hole are arranged side by side on the pull-out rod, and an aperture of the first through hole is larger than an aperture of the second through hole, so that the first channel is opened before the second channel. Through this solution, the shapes of the first through hole 311 and the second through hole 312 are not limited. They can be circular holes, square holes, etc. with constant aperture, or conical holes, etc. with smoothly changing aperture.

### Embodiment 4

As shown in FIG. 8, this embodiment is different from embodiment 1 in that: the valve core is two pull-out rods, the first through hole 311 and the second through hole 312 are respectively arranged on the two pull-out rods, the first channel is opened before the second channel by pulling the two pull-out rods in sequence. In this embodiment, the two pull-out rods are configured with different lengths for easy distinction, so as to effectively prevent operational errors.

In addition to the structures given in the above embodiments, the valve core can also be a sphere. The sphere is configured with an extension groove along a rotation direction at the first through hole, the extension groove is communicated to the first through hole, so that the first channel is opened before the second channel. It can also be: the first through hole and the second through hole are arranged side by side on the sphere, and an aperture of the first through hole is larger than an aperture of the second through hole, so that the first channel is opened before the second channel.

### Embodiment 5

The embodiment is a method for transferring liquid medicine from a low-pressure sealed container to a high-pressure sealed container comprising:
Step 1, ensuring that the on-off valve 3 is closed, the first channel A and the second channel B are blocked;
Step 2, piercing the first puncture end 1 and the second puncture end 2 into the low-pressure sealed container 5 and the high-pressure sealed container 6 respectively, wherein the low-pressure sealed container 5 is located above the high-pressure sealed container 6;
Step 3, driving the on-off valve 3, so that the first channel A is first in an open state, so that the gas in the high-pressure sealed container 6 flows to the low-pressure sealed container 5, the second channel B is in a closed state at this time;
Step 4, continuing to drive the on-off valve 3, so that the first channel A and the second channel B are simultaneously in an open state, so that the liquid in the low-pressure sealed container 5 flows into the high-pressure sealed container 6.

In the present embodiment, the on-off valve 3 is closed before piercing. When the low-pressure sealed container 5 and the high-pressure sealed container 6 are pierced respectively, the gas path passage (i.e., the first channel A) and the liquid path passage (i.e., the second channel B) are both in a blocked state. The gas path passage and the liquid path passage are opened successively after piercing, so as to ensure that the liquid does not splash or leak.

The above description is only a specific embodiment of the disclosure, but the protection scope of the disclosure is not limited thereto. Those skilled in the art should understand that the disclosure includes but is not limited to the contents described in the accompanying drawings and the above specific embodiments. Any modifications that do not depart from the functional and structural principles of the present disclosure are intended to be included within the scope of the claims.

1. A device for transferring liquid medicine from a low-pressure sealed container to a high-pressure sealed container comprising:
a first channel configured to be able to communicate the low-pressure sealed container with the high-pressure sealed container in gas;
a second channel configured to be able to communicate the low-pressure sealed container with the high-pressure sealed container in liquid;
a first puncture end configured to pierce the low-pressure sealed container, wherein first ends of the first channel and the second channel are located at the first puncture end;
a second puncture end configured to pierce the high-pressure sealed container, wherein second ends of the first channel and the second channel are located at the second puncture end;
an on-off valve arranged on the first channel and the second channel, and configured to control the opening and closing of the first channel and the second channel, wherein the first channel is opened before the second channel.

2. The device for transferring liquid medicine from a low-pressure sealed container to a high-pressure sealed container according to claim 1, wherein the on-off valve comprises a valve core configured with a first through hole and a second through hole, the first through hole and the second through hole are respectively located in a middle position of the first channel and the second channel, and the first channel is opened before the second channel by driving the valve core.

3. The device for transferring liquid medicine from a low-pressure sealed container to a high-pressure sealed container according to claim 2, wherein the valve core is a rotary shaft, the first through hole and the second through hole are arranged side by side on the rotary shaft, the rotary shaft is configured with an extension groove along a rotation direction at the first through hole, the extension groove is communicated to the first through hole, so that the first channel is opened before the second channel.

4. The device for transferring liquid medicine from a low-pressure sealed container to a high-pressure sealed container according to claim 2, wherein the valve core is a rotary shaft, the first through hole and the second through hole are arranged side by side on the rotary shaft, and an aperture of the first through hole is larger than an aperture of the second through hole, so that the first channel is opened before the second channel.

5. The device for transferring liquid medicine from a low-pressure sealed container to a high-pressure sealed container according to claim 2, wherein the valve core is a pull-out rod, the pull-out rod is configured with an extension groove along a pull-out direction at the first through hole, the extension groove is communicated to the first through hole, and the distance between the extension groove and the first channel in the pull-out direction is smaller than the distance between the second through hole and the second channel, so that the first channel is opened before the second channel.

6. The device for transferring liquid medicine from a low-pressure sealed container to a high-pressure sealed container according to claim 2, wherein the valve core is two pull-out rods, the first through hole and the second through hole are respectively arranged on the two pull-out rods, the first channel is opened before the second channel by pulling the two pull-out rods in sequence.

7. The device for transferring liquid medicine from a low-pressure sealed container to a high-pressure sealed container according to claim 2, wherein the device further comprises a housing connecting the first puncture end and the second puncture end, the valve core is arranged in the housing, the housing and the valve core are matched through a groove and a buckle, so as to determine the driving position of the valve core.

8. The device for transferring liquid medicine from a low-pressure sealed container to a high-pressure sealed container according to claim 7, wherein the housing is configured with a holder extending toward the first puncture end, the holder is configured to fix or clamp the low-pressure sealed container.

9. The device for transferring liquid medicine from a low-pressure sealed container to a high-pressure sealed container according to claim 2, wherein the first end of the first channel is higher than the first end of the second channel, wherein the end of the first channel is located above liquid in the low-pressure sealed container, so that an end of a first communication tube is able to contact the gas in the low-pressure sealed container and the end of the second channel is submerged in the liquid in the low-pressure sealed container.

10. The device for transferring liquid medicine from a low-pressure sealed container to a high-pressure sealed container according to claim 2, wherein the second end of the first channel is higher than the second end of the second channel, and the height difference between them is greater than a height of a rubber stopper of the high-pressure sealed container.

11. A method for transferring liquid medicine from a low-pressure sealed container to a high-pressure sealed container by means of the device for transferring liquid medicine from a low-pressure sealed container to a high-pressure sealed container according to claim 1, comprising:
Step 1, ensuring that the on-off valve is closed, the first channel and the second channel are blocked;
Step 2, piercing the first puncture end and the second puncture end into the low-pressure sealed container and the high-pressure sealed container respectively, wherein the low-pressure sealed container is located above the high-pressure sealed container;
Step 3, driving the on-off valve, so that the first channel is first in an open state, so that the gas in the high-pressure sealed container flows to the low-pressure sealed container, the second channel is in a closed state at this time;
Step 4, continuing to drive the on-off valve, so that the first channel and the second channel are simultaneously in an open state, so that the liquid in the low-pressure sealed container flows into the high-pressure sealed container.
